(19) United States
(12) Patent Application Publication
(10) Pub. No.: US 2008/0131046 A1
(43) Pub. Date: Jun. 5, 2008

(54) Apparatus and method for manufacturing knuckle and bearing assembly

(76) Inventor: Glenn R. Weier, Waterford, MI (US)

Correspondence Address: MCDONALD HOPKINS LLC, 600 Superior Avenue, East, Suite 2100, CLEVELAND, OH, 44114-2653, US

(21) Appl. No.: 11/982,437

(22) Filed: Nov. 1, 2007

Related U.S. Application Data
(60) Provisional application No. 60/855,897, filed on Nov. 1, 2006.

(51) Int. Cl. F16C 35/07; B23P 17/04

(52) U.S. Cl. 384/589; 29/592

(57) ABSTRACT

A method is provided for manufacturing a knuckle and bearing assembly. The method comprises providing a knuckle and bearing assembly comprising a knuckle, a bearing secured to the knuckle, and a wheel hub having a neck portion in rotational communication with the bearing and a flange portion having a flange face, applying a load longitudinally along the knuckle and bearing assembly to simulate compressive forces encountered by a knuckle and bearing assembly when installed on a vehicle, and machining the flange face during the application of the load to minimize lateral run-out.

### CROSS-REFERENCE TO RELATED APPLICATIONS

This application claims priority from U.S. Provisional Patent Application No. 60/855,897, entitled “Apparatus and Method for Manufacturing Knuckle and Bearing Assembly,” filed on Nov. 1, 2006, which is hereby incorporated by reference herein.

### FIELD OF THE INVENTION

The present invention relates generally to an apparatus and a method for manufacturing motor vehicle wheel end components and, more particularly, to an apparatus and a method for manufacturing a knuckle, hub, and bearing assembly.

### BACKGROUND

Motor vehicles have disc brake systems for the front and rear axle assemblies. The disc brake rotor is a circular metal disc having opposed braking surfaces that are clamped by brake pads to exert a braking effect. The wheel hub typically incorporates an anti-friction wheel bearing assembly, in which one race of the bearing is coupled to the vehicle suspension and the other race rotationally mounts to the wheel hub, the brake rotor, and wheel. The modular assembly of the brake rotor, hub, and bearing enables the brake rotor to be serviced and/or replaced. Ordinarily, the rotating components of the rotor and hub assembly are manufactured separately and are assembled together.

In order to enhance performance of the braking system, it is desired to accurately control the dimensional characteristics of the rotor braking surfaces. The thickness variation of the disc and the lateral run-out or lateral deflection of the rotor surfaces should be minimized. The failure to adequately reduce these tolerances results in the interaction of the brake pad and the rotor during rotation and braking during normal operation. Lateral run-out at the rotor in final assembly is a key measure of this interaction. The run-out problems are caused by other components of the wheel end assembly, such as the knuckle, bearing, and hub assembly. This run-out can cause premature failure of the brake lining due to uneven wear, which requires premature replacement of the brake lining at an increased expense. However, multiple factors have prevented manufacturers from minimizing lateral deflection and run-out.

Most manufacturers have focused on decreasing run-out by controlling the dimensional characteristics of the rotor and the relationship of the rotor surface to the wheel hub flange or surface. However, despite improving the tolerances and dimensional characteristics of the rotors, performance and run-out problems still exist.

For example, a major factor contributing to run-out is the stack-up of tolerances of the individual components in a knuckle, bearing, and hub assembly, i.e., the tolerances of the components combined. While the tolerance of each component may be reduced during manufacturing, the combined tolerances stack-up, causing significant run-out. In other words, when components are assembled, each component will “stack” these variables to reach a final “dynamic” centerline that is the result of the sum of the errors from zero tolerance plane and zero tolerance bores.

Presently known methods have focused merely on reducing variables in the static rotational centerline of each component (e.g., reducing the run-out of each individual component by decreasing their respective tolerances during manufacture and then assembling the components). The stack-up of tolerance variations related to such an approach is still significant and provides only limited system improvement at a significantly increased manufacturing cost by, for example, additional operations, and increases in scrap material due to limitations in production controls and material quality. In addition, insertion of studs “post” hub face machining deforms the hub mount surface prior to assembly.

Another factor contributing to stack-up is the variation in the turning processes used to machine the wheel hub flange surface and the rotor surface. The wheel hub and the rotor are individually machined in an effort to make them flat. Further, the installation and pressed condition of the wheel bolts, the assembly process of the knuckle and hub assembly, and improperly pre-loaded bearings all can cause misalignment of the rotor surface with respect to the brake pads.

Prior manufacturing methods and designs of rotors and knuckle and hub assemblies typically involve finishing the rotor and hub individually and then assembling the machined parts to form a completed brake rotor assembly. A separately manufactured bearing is present only in the final assembly of the knuckle and hub assembly. However, these methods do not solve the run-out problems caused by the factors discussed above, including stack-up tolerances, turning process variations, and wheel bolt and bearing installations.

Another contemplated option includes tightening the press-fit tolerance variation between the knuckle, the wheel hub, and the bearing. This, however, significantly increases the difficulty of the assembly process, as well as increasing the manufacturing cost. Moreover, this option does not provide the desired reduction in system run-out.

Finally, there is an inherent error in manufacturing the knuckle, bearing, and hub assembly when the components are not under final assembly load, such as in the vehicle when the half shaft spindle is installed and loaded. The change in non-loaded and loaded bearings is significant, in that the final position of the bearing balls and race are influential to the “dynamic” centerline as defined in rotation.

Therefore, a need exists for an apparatus and method for manufacturing a knuckle, bearing, and hub assembly that minimizes run-out in a cost-effective manner. Further, a need exists for an apparatus and method for manufacturing an assembled knuckle, bearing, and hub assembly having reduced run-out prior to installation on a vehicle. In addition, a need exists for an apparatus and method for producing a knuckle, bearing, and hub assembly with reduced lateral run-out that can be installed onto a vehicle without requiring further machining.

### SUMMARY OF THE INVENTION

Accordingly, the present application discloses an apparatus and a method for manufacturing a knuckle, bearing, and hub assembly of a vehicle. The method for manufacturing a knuckle and bearing assembly, comprises providing a knuckle and bearing assembly comprising a knuckle, a bearing secured to the knuckle, and a wheel hub having a neck portion in rotational communication with the bearing. The wheel hub also may have a flange portion attached to the neck portion, the flange portion having a flange face. The method also comprises applying a load longitudinally along the knuckle and bearing assembly to simulate compressive forces encountered by a knuckle and bearing assembly when installed on a vehicle, and machining the flange face during the application of the load to minimize lateral run-out.

### BRIEF DESCRIPTION OF THE DRAWINGS

The operation of the invention may be better understood by reference to the following detailed description taken in connection with the following illustrations, wherein:

FIG. 1 is a perspective view of a knuckle, bearing, and hub assembly.

FIG. 2 is an exploded view of a knuckle, bearing, and hub assembly.

FIG. 3 is an exploded cross-sectional view illustrating the components of a knuckle, bearing, and hub assembly and a brake rotor.

FIG. 4 is a cross-sectional view of the knuckle, bearing, and hub assembly.

FIG. 5 is a perspective view of an apparatus for applying load to the bearing and hub assembly in an embodiment of the present invention.

FIG. 6 is a cross-sectional view of the apparatus of FIG. 5 inserted in the knuckle, bearing, and hub assembly in an embodiment of the present invention.

FIG. 7 is a perspective view of the apparatus of FIG. 5 with a strain gage in an embodiment of the present invention.

FIG. 8 is a perspective view of an OEM vehicle half-shaft with a strain gage.

FIG. 9 is a perspective view of a machine capable of applying a load to a knuckle, bearing, and hub assembly in an embodiment of the present invention.

FIG. 10 is a perspective view of a pallet in an embodiment of the present invention.

FIG. 11A is a perspective view of a collet in an embodiment of the present invention.

FIG. 11B is a cross-sectional view of FIG. 11A showing channels and a point locator of a collet in an embodiment of the present invention.

FIG. 12 is a cross-sectional view of a collet securing a knuckle, bearing, and hub assembly in an embodiment of the present invention.

### DETAILED DESCRIPTION OF THE INVENTION

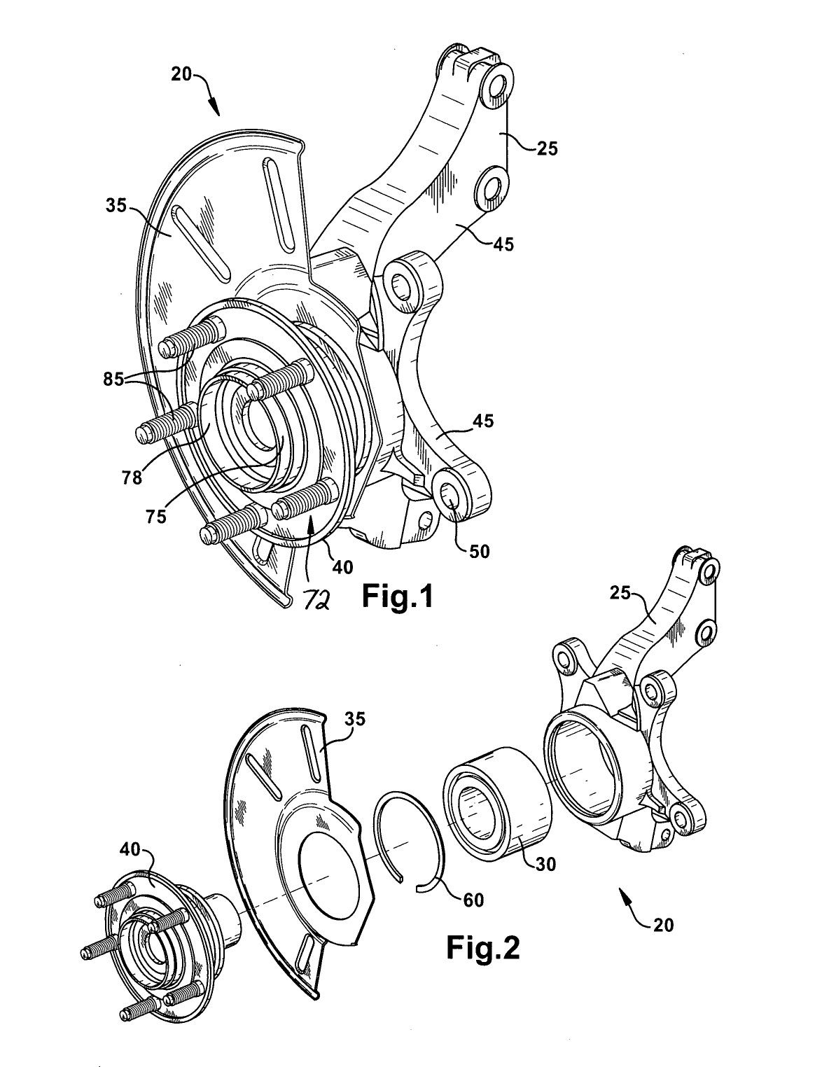

The present invention will now be described in accordance with the embodiment as shown in FIGS. 1-12. While the embodiments are described with reference to a knuckle, bearing, and hub assembly for vehicles, it should be clear that the present invention can be used with other press-fit assemblies, as will be appreciated by one of ordinary skill in the art.

A knuckle, bearing, and hub assembly 20 (hereinafter referred to as “the assembly 20” or “knuckle and bearing assembly 20”) is illustrated in FIGS. 1-4. An apparatus and a method are provided for manufacturing the assembly 20. More specifically, an apparatus and a method are provided for machining a hub 40 when assembled with the assembly 20. In addition, the apparatus is capable of simulating vehicle load and machining the hub 40 while the assembly 20 is in such a loaded state. Advantageously, the load environment allows the assembly 20 to be attached to a vehicle with a half shaft without further machining.

The assembly 20 and other methods of making and manufacturing the assembly 20 are presented in greater detail in U.S. Pat. No. 6,485,109, granted Nov. 26, 2002, to Brinker et al.; U.S. Pat. No. 6,450,584, granted Sep. 17, 2002, to Brinker et al.; U.S. Pat. No. 6,634,266, granted Oct. 21, 2003, to Brinker et al.; U.S. Pat. No. 6,708,589, granted Mar. 23, 2004, to Brinker et al.; and U.S. patent application Ser. No. 11/387,604, filed Mar. 23, 2006, to Mestre, the disclosures of each are fully incorporated herein by reference.

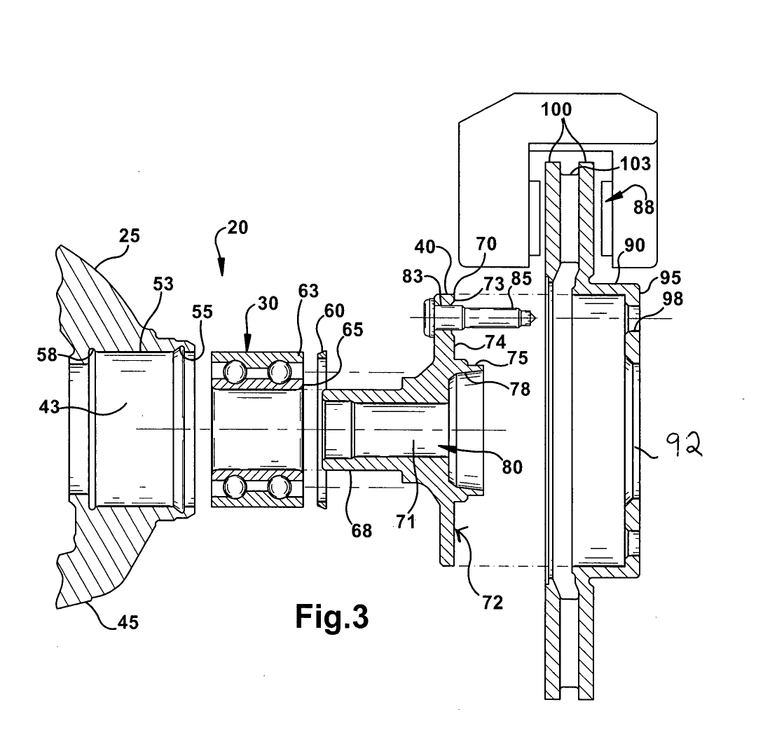

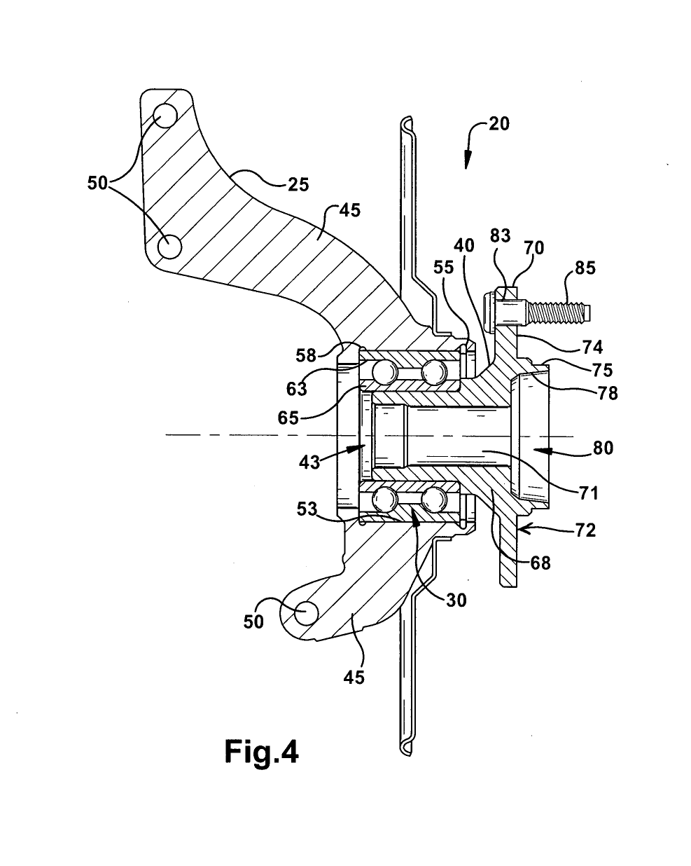

FIG. 2 illustrates an exploded view of the assembly 20 that comprises a knuckle 25, a bearing 30, a cover or dust shield 35, and the hub 40. The knuckle 25 and the hub 40 may be constructed of a hard, durable material, such as metal and may be formed by any method, such as casting or forging. As shown in FIGS. 3 and 4, the knuckle 25 has a bore 43 formed therein and a plurality of outwardly extending legs 45 that are attachable to a vehicle through apertures 50 formed in the legs 45.

As best shown in FIG. 3, the bore 43 may have a recess 53 formed therein that is bounded by an upper snap ring groove (or retention ring) 55 and a lower snap ring (or retention ring) 58 or shoulder for receiving the bearing 30 therein. A snap ring 60 may be secured into the upper snap ring groove 55 prior to engagement of the bearing 30 with the knuckle 25. It is to be understood that, while the illustrated assembly has a bore 43 formed in the knuckle 25, the bearing 30 may be attached or may be secured to the knuckle 25 in a variety of configurations. For example, the bearing 30 can be mounted to an upper surface or other portion of the knuckle 25. The bearing 30 may be partially disposed in the bore 43 or may be eliminated.

Typically, the bearing 30 has an outer race 63 and an inner race 65. However, it should be understood that a variety of different bearings may be utilized, as well as a variety of different knuckle/bearing attachment configurations. For example, instead of being press-fit with a snap ring 60, i.e., between the upper retention ring 55 and the lower retention ring 58, the bearing 30 may be press-fit without a snap ring 60 and may be secured with a nut or other fastener. Alternatively, the outer race 63 may be integrally formed with the knuckle 25 or may be configured as an orbital formed outer race rotation bearing/knuckle assembly. Further, the outer race 63 could alternatively be bolted to the knuckle 25 such that the inner race 65 rotates with the wheel hub 40. Moreover, the inner race 65 may be integrally formed with the wheel hub 40. Further, a spindle configuration having a non-driven outer race rotation may also be utilized.

As shown in FIG. 3, the wheel hub 40 has a neck portion 68, a flange portion 70, and a bore 71. As shown in FIG. 4, the neck portion 68 may be pressed into contact with the inner race 65 of the bearing 30 such that the wheel hub 40 is rotatable with respect to the knuckle 25. Alternatively, the neck portion 68 may be integrally formed with the inner race 65 or the outer race 63. It is to be understood that other wheel hub/bearing configurations may also be utilized.

As best shown in FIG. 3, the flange portion 70 has a flange face 72 and a wheel and rotor pilot portion 75. The flange face 72 generally has an outer flange surface 73 and an inner flange surface 74. The wheel and rotor pilot portion 75 extends generally outwardly from the flange face 72 and has an inner surface 78, which defines a spline 80. The wheel hub 40 also has bolt holes 83 formed in the flange face 72, through which wheel bolts 85 extend there through. The wheel bolts 85 are attached to the flange face 72 in a predetermined pattern and may be on the same pitch circle diameter. The wheel bolts 85 may have threaded ends extending outwardly to connect a rotor 95 and associated wheel onto the hub 40. In another embodiment, the bolt holes 83 may receive lug nuts that are attached to a vehicle wheel and are passed through the bolt holes 83 when the wheel is attached to the wheel hub 40.

As best shown in FIG. 3, rotor 95 mounts on pilot diameter 75 in retention with wheel (not shown) mounted on rotor 95 in retention by, for example, nuts (not shown) on studs 85. Annular discs 100 spaced from each other by a plurality of rectangular fillets 103 may extend outwardly from the cup 90 and define braking surfaces for a plurality of brake calipers 88. The wheel is positioned over the bolts 85, and the nuts (not shown) are threaded to the bolts 85 to secure the wheel between the nuts and the rotor 95.

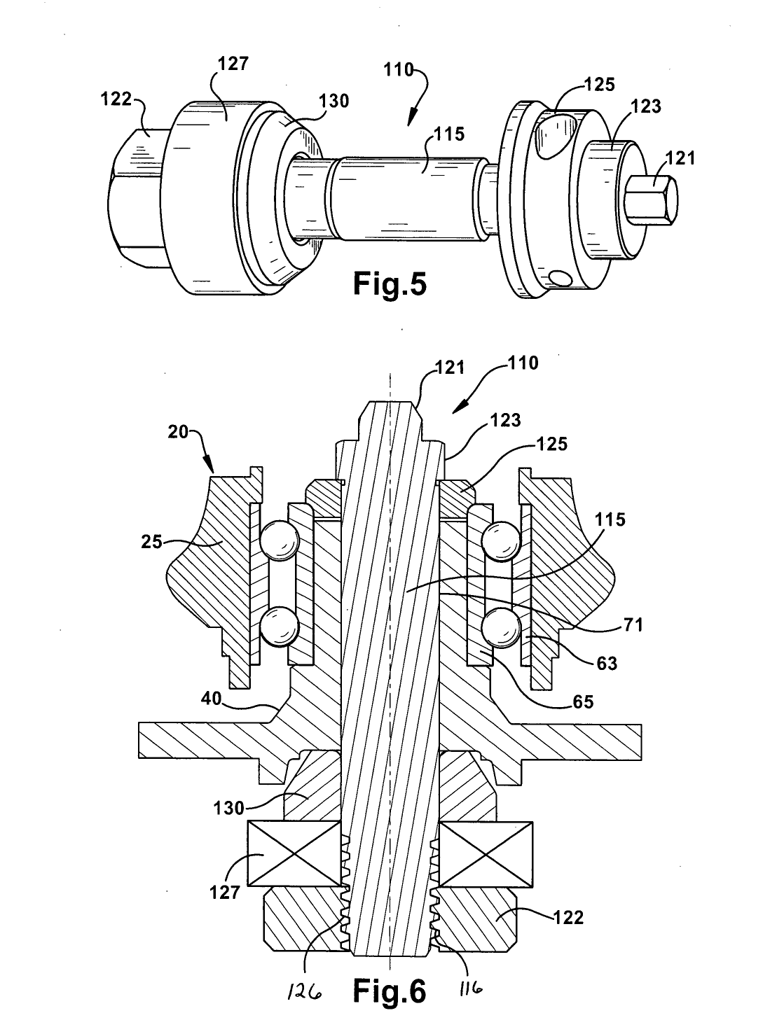

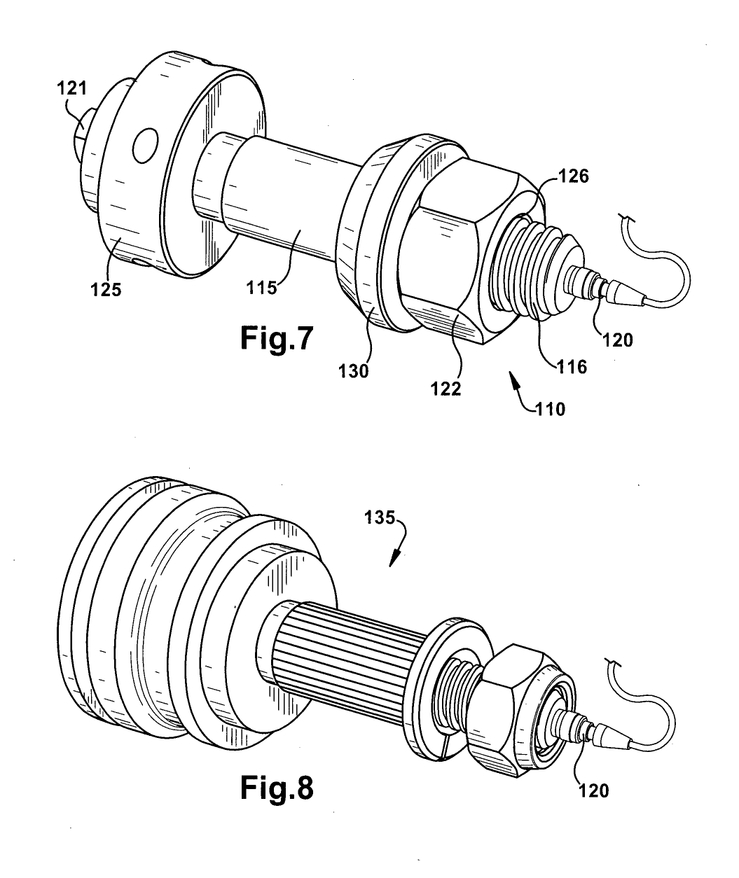

The present invention provides an apparatus and a method for manufacturing the assembly 20 that minimizes lateral run-out. As set forth above, an apparatus 110 as shown in FIG. 5 is provided for accurately straining the assembly 20 to simulate a vehicle load prior to machining of the hub 40. The apparatus 110 may generally comprise a shaft 115, an upper washer 125, a retention nut 122, and a biasing or capture load member 127 and a lower washer 130. The shaft 115 may be made of any suitably rigid material, such as steel, and sized such that the shaft 115 is capable of being inserted through the assembly 20 via the bore 71, as shown in FIG. 6. A drive point or head 121, such as a hex drive point, may be provided at one end of the shaft 115 for applying torque to the shaft 115.

The shaft 115 may be provided with a protuberance or shoulder 123 substantially adjacent to the drive point 121. The shoulder 123 may prevent removal of the shaft 115 from the assembly 20 while the load is applied to and/or the load is maintained on the assembly 20. It is to be understood that the shoulder 123 may be integrally formed with, welded to, or removeably secured to the shaft 115. Accordingly, the shoulder 123 may be removed to position the assembly 20 on the shaft 115. It is also understood that the drive point 121 and the shoulder 123 may be combined, for example, as a bolt head. As shown in FIG. 6, the upper washer 125 may be positioned between the shoulder 123 and the inner race 65 to aid in uniformly applying a load onto the assembly 20.

As shown in FIG. 6, the opposite end of the shaft 115 is provided with threads 116 to accommodate the retention nut 122, such as a hex nut or the like. The retention nut 122 has an internally threaded bore 126 for threadingly engaging the shaft 115. Accordingly, the shaft 115 is capable of being rotated and moving axially through the retention nut 122 to compress the assembly 20 between the retention nut 122 and the shoulder 123. The lower washer 130 may be positioned between the retention nut 122 and the hub 40 to prevent damage to the assembly 20 or any component thereof.

As shown in FIG. 6, the capture load member 127 may be positioned between the retention nut 122 and the lower washer 130. The capture load member 127 may be positioned anywhere between the retention nut 122 and the protuberance 123. The capture load member 127 is capable of maintaining a load on the assembly 20 by transferring mechanical energy from the capture load member 127 to the assembly 20. Accordingly, the capture load member 127 pushes against both the hub 40 and the retention nut 122 so as to place and/or to maintain the assembly 20 under compression by, for example, washer 125. The capture load member 127 may be a load washer, such as a Belleville washer(s), a spring(s), compression spring(s), a tension spring(s), an hydraulic actuator(s), a pneumatic actuator(s), bellows, or the like. However, one of ordinary skill in the art will appreciate that other methods may be used to maintain the bearing load on the assembly 20.

As shown in FIG. 7 (biasing member 127 not shown), a strain gage 120 may be operably connected to the shaft 115 to accurately measure the strain on the shaft 115 and/or the resistance force of the assembly 20. In one illustrative embodiment, as a load is applied to the assembly 20, the assembly 20 applies a force against the upper washer 125, lower washer 130, capture load member 127, and the retention nut 122 to resist the load. The strain gage 120 may measure the amount of resistance force of the assembly 20. In such an embodiment, the strain gage 120 accurately measures the strain on the assembly 20 rather than merely the torque applied to the shaft 115, such as the force applied to rotate the retention nut 122 or the shaft 115.

The strain gage 120 is connectable to a processing unit (not shown) for calibration and for conversion (or correlation) of the amount of strain on shaft 115 to a load value on the assembly 20. The load value may be compared to vehicle bearing load specifications from OEM vehicle and bearing manufacturers to ensure that the load applied to the assembly 20 simulates actual vehicle loads. Specifically, the strain gage 120 data may be compared to vehicle load data obtained from an actual vehicle half-shaft assembly 135, as illustrated in FIG. 8. It is understood that vehicle load data may be obtained from a variety of vehicles. For example, strain gage data and the zero point of the hub 40 position may be compared against data obtained from the half-shaft assembly 135. The flange face 72, such as the outer 73 and inner 74 surfaces of the hub 40 may then be machined at an amount of strain correlating to a load that is substantially the same as an actual vehicle load. In one embodiment, the load at which the assembly 20 is machined may be substantially the same as the load experienced on a vehicle that the assembly 20 will be installed on.

In one illustrative embodiment, a delta from unloaded to loaded states may be defined. Process shaft 115 and half shaft 135 may be mastered to zero values (Z and z1 respectively). These values may be verified and rechecked prior to defining a delta value on half shaft 135 loaded and process shaft 110 loaded values. Half shaft 135 is assembled into assembly 20 and torqued to specifications stated by OEM bearing supplier. The new L1 value taken from Z1 gives the delta value F. Applying torque to the assembly 20 with process shaft 110 (for example, by torquing the drive head 121) to achieve value F are achieved and validate the capture load sustained by capture load member 127. Final validation may be done in a press load station 140 to validate and verify preloading of the assembly 20 after press load station 140 is disengaged.

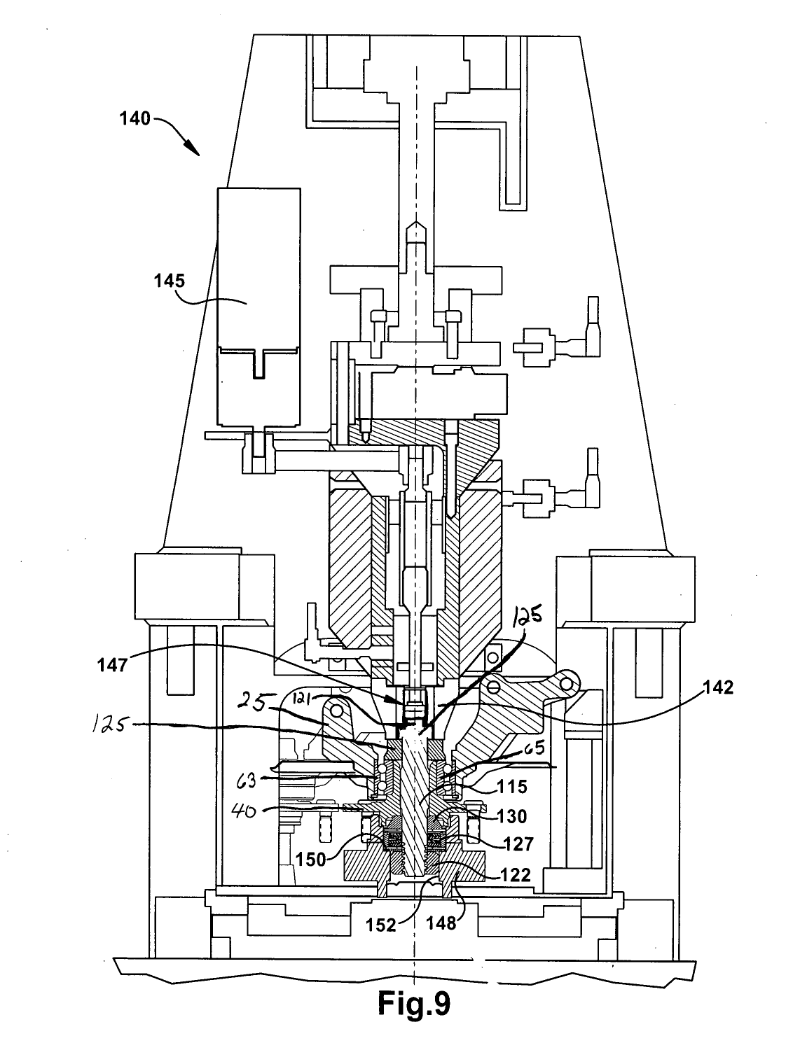

As shown in FIG. 9, the apparatus 110 may be incorporated into a station or a machine 140 capable of applying a load to the assembly 20. In an embodiment, the machine 140 applies a load to the assembly 20 that substantially simulates vehicle loads determined by actual vehicle load correlation studies, as set forth above. As shown in FIG. 9, the machine 140 may be provided with a press tooling 142 and a torque tooling 147. The press tooling 142 is capable of engaging, for example, the bearing washer 125 to compress the assembly 20 to substantially the desired load.

The station 140 may be provided with a motor 145 capable of rotating the torque tooling 147, such as a drive nut. The torque tooling 147 is sized and shaped to engage the drive point 121 and rotate the shaft 115. It is to be understood that the torque tooling 147 may have a free angular float detail to ensure that influences by the torque tooling 147 are not transferred into the shaft 115. As torque is applied to the drive point 121, the shaft 115 rotates and moves axially through the assembly 20 and retention nut 122. Accordingly, the retention nut 122 is capable of being positioned along the shaft 115 such that the capture load member 127 maintains the bearing load applied to the assembly 20 by the press tooling 142.

It is to be understood that adjustments to the load may be made with the torque tooling 147. In one illustrative example, the torque tooling 147 rotates the shaft 115 clockwise to increase the load on the assembly 20 and counterclockwise to decrease the load. In an embodiment, the machine 140 may not require use of the press tooling 142 to apply the load to the assembly 20.

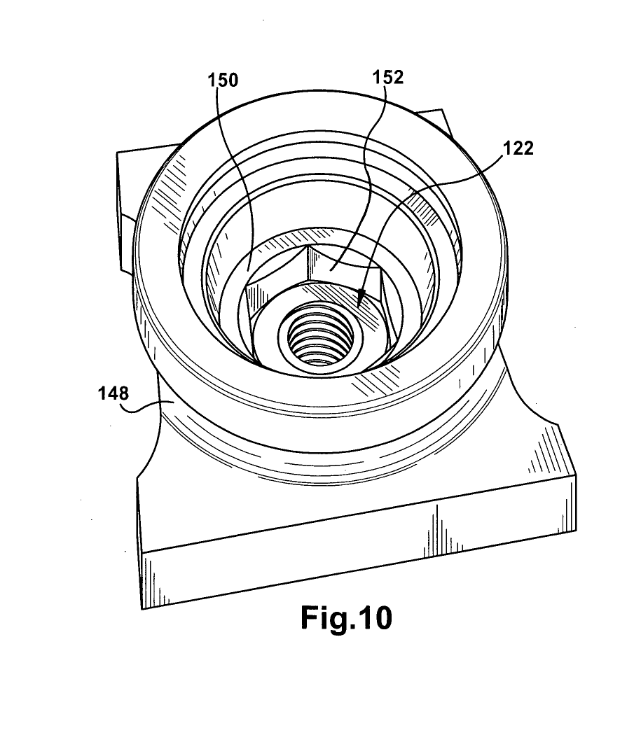

It is to be understood that the assembly 20 may be positioned on a pallet or fixture plate 148, as shown in FIG. 10. The pallet 148 secures the apparatus 110 and the assembly 20 during application of the load. The pallet 148 may be provided with a shoulder 150 to support the capture load member 127 during load application on the assembly 20 with the press tooling 142. A recess or aperture 152 may be provided to rotationally secure the retention nut 122 and allow the shaft 115 to axially move through during rotation with the torque tooling 147. In an embodiment, the pallet 148 is also capable of securing the assembly 20 and apparatus 110 during, for example, transport to and from stations on an assembly line. In such an embodiment, the machine 140 may be incorporated into an assembly line, automated system, robotic system, or the like.

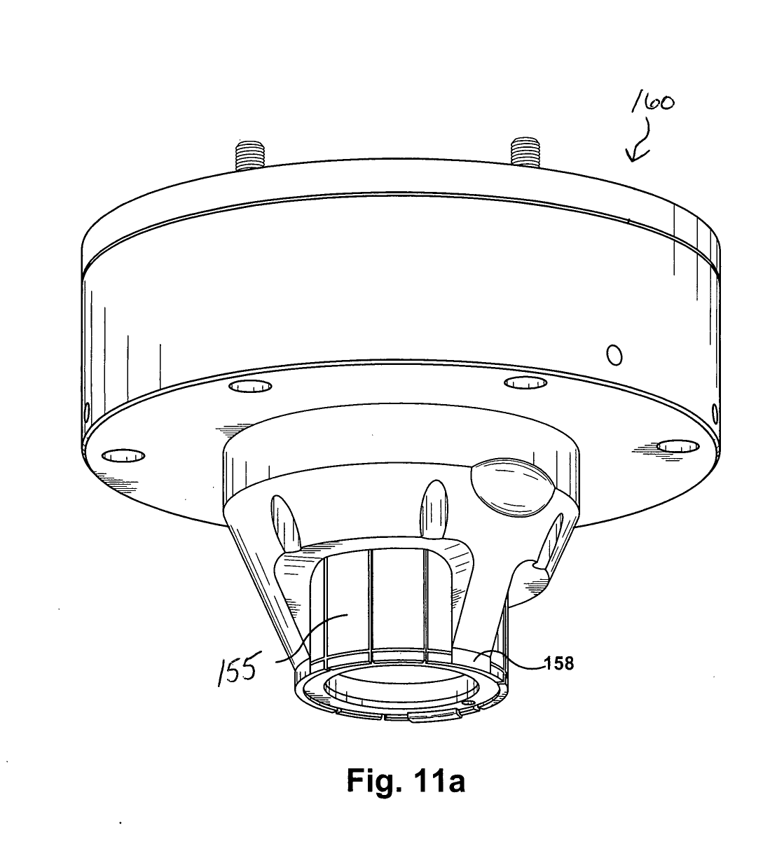

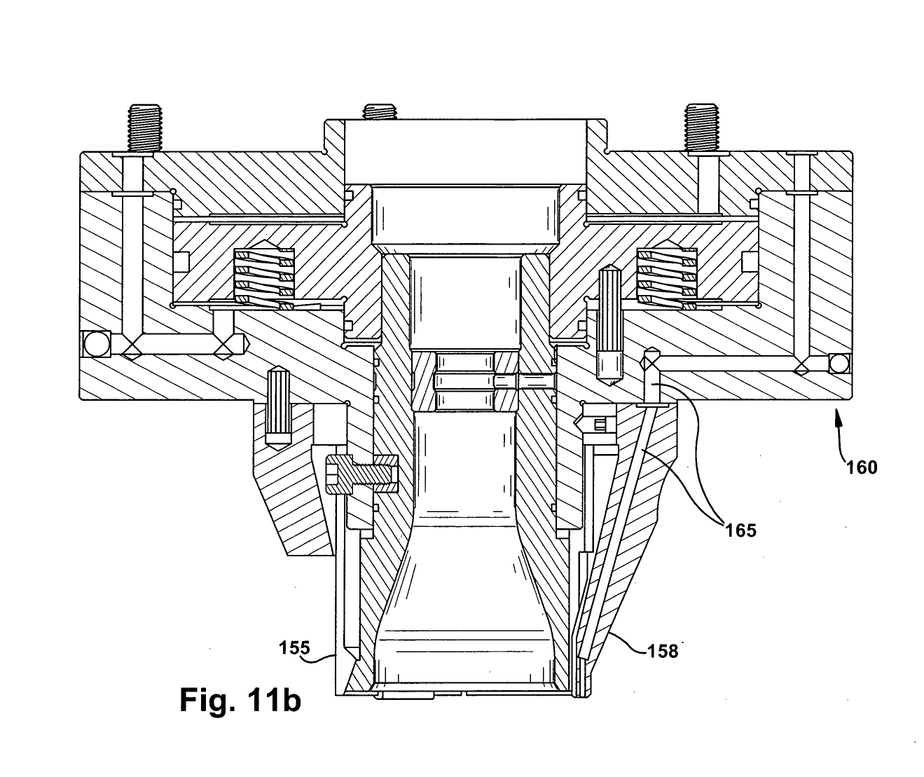

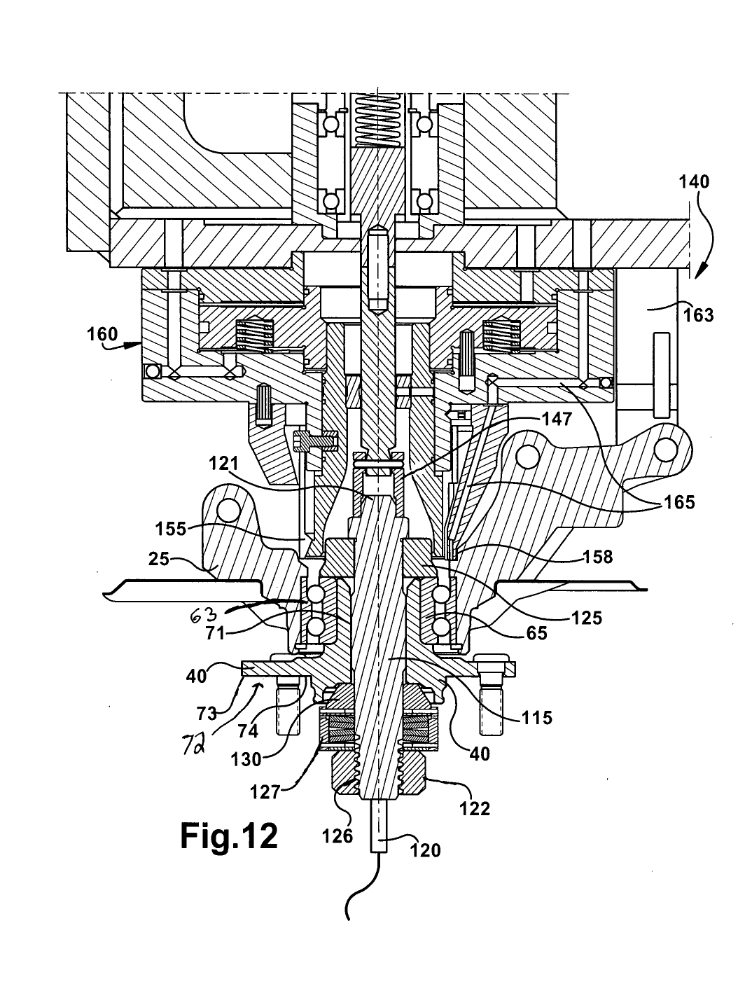

With the assembly 20 in a strained state, the hub 40 may/or is accurately machined to substantially reduce run-out. As shown in FIGS. 11A and 11B, a collet 155 may be provided for engaging the knuckle 25 prior to machining of the hub 40. The collet 155 may be attached to, connected to, or integrally formed with the fixture 160. The collet 155 expands to engage the knuckle 25 and pull the knuckle 25 into the fixed collet solid locators 158, as best shown in FIG. 12. The collet 155 and fixed collet solid locators 158 grip or otherwise secure the knuckle 25, while allowing the bearing 30, hub 40, and shaft 115 to freely rotate during the machining process. It is to be understood that an additional grip 163 may be used to secure the knuckle 25 to prevent rotation of the knuckle 25 during machining of the hub 40.

In an embodiment, one or more sensors 165 may be provided to insure that the knuckle 25 is properly secured such that the assembly 20 is held flat and within process limits prior to cutting or machining. For example, the sensors 165 may be apertures or passages that sense the location of the assembly 20 by use of fluid passing through the apertures or passages. Air or other fluid may flow through the sensors 165 to ensure that the assembly 20 is properly positioned. It is to be understood, however, that other types of sensors 165 may be used to insure proper positioning of the assembly 20.

In an embodiment, the drive 147 has angular freedom to drive nut 121, this provides a non-compliant method of rotational drive to the hub 40 and bearing 30 for machining the flange face 72, such as surfaces 73 and 74. This aids to the assembly rotating in a free state about a free dynamic centerline as seen in the final assembly on the vehicle.

After properly positioning the assembly 20, the inner 74 and outer 73 flange surfaces of the hub 40 are machined. Typically, the hub 40 is machined with an inverted vertical lathe, such as a CNC lathe (not shown). However, it is to be understood that other machines may be used for machining the hub 40.

The machined hub 40 may be measured to determine a dynamic value of the machined assembly 20. For example, the knuckle 25 may be secured so that the hub 40 may be rotated. During rotation, the lateral run-out of the flange face 72, such as one or both of surfaces 73, 74, may be measured, for example, with a Linear Variable Displacement Transducer (LVDT) to determine the dynamic value. The dynamic value of the machined hub 40 may be compared to a certified standard hub or master (not shown) having a known lateral run-out range (hereinafter referred to as “master range”). The master range may be stored in the machine cell to compare with the dynamic value, to calibrate the Linear Variable Displacement Transducer (LVDT), and to audit the process during normal and abnormal operation. In an illustrative example, the master range is 6-8 μm. In such an example, if the machined hub 40 has a lateral run-out greater than 10 μm, then the hub 40 may be cut or machined a second time. It is understood, however, that the acceptable lateral run-out range, or tolerance, may be increased, decreased, or otherwise modified depending on the application. In one illustrative example, if the machined hub 40 has a lateral run-out greater than 6-8 μm, then the hub 40 may be cut or machined a second time.

Turning now to the apparatus 110, use of the apparatus 110, as illustrated in FIGS. 5-12, is set forth below. An assembly 20 may be provided, or a knuckle 25, hub 40, and bearing 30 may be provided to assemble the assembly 20. As best shown in FIG. 6, the shaft 115 may be inserted through the hub 40 of an assembly 20 such that the assembly 20 may be secured on the apparatus 110 between retention nut 122 and the shoulder 123. The assembly 20 and the apparatus 110 may be positioned on the pallet 143 and transported to the machine 140 for application of the bearing load to the assembly 20. As shown in FIG. 9, the press tooling 142 engages the upper washer 125 to compress the capture load member 127 and to apply a bearing load to the assembly 20 that is substantially equivalent to the bearing load of a vehicle. The shoulder 150 of the pallet 143 supports the capture load member 127 during the press stage of the process.

While the assembly 20 is under the load, the torque tooling 147 engages the drive point 121 to rotate the shaft 115. The recess 152 in the pallet 148 rotationally secures the retention nut 122 such that the shaft 115 may move axially therethrough. The shaft 115 may be rotated until the retention nut 122 abuts the capture load member 127 to maintain the capture load member 127 in a compressed state. Accordingly, the capture load member 127 maintains the load on the assembly 20 when the press tooling is released. Further adjustments to the bearing load may be made by rotating the shaft 115 with the torque tooling 147. It is to be understood, however, that the load may be applied to the assembly 20 via the torque tooling 147 alone (without the press tooling 142).

The knuckle 25 may be secured to allow rotation of the bearing 30 and hub 40. The assembly 20 may be measured to establish the zero point position of the hub 40. The zero point may be used to establish the cutting position or pattern of the cutting machine (not shown). The assembly 20 may be moved to the machining area to machine the surfaces 73, 74. The assembly 20 may then be moved to a measuring area, and the knuckle 25 may be secured so that the hub 40 can freely rotate. An LVDT, for example, measures the dynamic value of the assembly 20 for comparison of the dynamic value to the master range. If the dynamic value is not within the master range, the assembly 20 can be machined until it is within an acceptable range, with in stock allowances on flange face 72, such as surfaces 73 and 74.

If the dynamic value is acceptable, the assembly 20 may be released and transported to an unloading station. An additional load may be applied to the assembly 20, and the torque tooling 147 may torque the drive point 121 to rotate the shaft 115 to loosen the retention nut 122. The additional load may be released and the retention nut 122 may be removed from the shaft 115 such that the assembly 20 may also be removed, enabling the assembly 20 to be installed on a vehicle.

Although the preferred embodiment of the present invention has been illustrated in the accompanying drawings and described in the foregoing detailed description, it is to be understood that the present invention is not to be limited to just the preferred embodiment disclosed, but that the invention described herein is capable of numerous rearrangements, modifications, and substitutions without departing from the scope of the claims hereafter.

Having thus described the invention, I claim:

1. A method for manufacturing a knuckle and bearing assembly, comprising:
providing a knuckle and bearing assembly comprising:
a knuckle;
a bearing secured to said knuckle;
a wheel hub having a neck portion in rotational communication with said bearing, a flange portion attached to said neck portion, said flange portion having a flange face;
applying a load longitudinally along said knuckle and bearing assembly to simulate compressive forces encountered by a knuckle and bearing assembly when installed on a vehicle; and
machining said flange face during said application of said load to minimize lateral run-out.

2. The method of claim 1, wherein said step of applying said load includes:
providing a shaft having a threaded first end and a second end having a drive head;
inserting said first end through said knuckle and bearing assembly; and
threading a nut on said first end to secure said knuckle and bearing assembly on said shaft between said drive head and said nut.

3. The method of claim 2, wherein said step of applying a load further includes rotating said drive head so that said shaft moves axially through said knuckle and bearing assembly to compress said bearing and said hub of said knuckle and bearing assembly between said nut and said drive head.

4. The method of claim 3 wherein a biasing member is positioned on said shaft between said nut and said drive head.

5. The method of claim 4 wherein said biasing member is a Belleville washer.

6. The method of claim 3 wherein a strain gage is operably connected to said shaft to measure a strain on said shaft during said application of said load.

7. The method of claim 6 wherein said strain is correlated to measure said load on said bearing of said knuckle and bearing assembly.

8. The method of claim 3 wherein said rotation is applied to said drive head with a torque tooling having a free angular float detail.

9. The method of claim 2 wherein said step of applying a load includes:
compressing said bearing of said knuckle and bearing assembly with a press tooling; and
rotating said drive head to move said shaft axially through said knuckle and bearing assembly to secure said bearing and said hub of said knuckle and bearing assembly between said nut and said drive head to maintain said load.

10. The method of claim 1 wherein said flange face is machined with a cutting tool.

11. The method of claim 10, wherein said step of machining further comprises:
securing said knuckle of said knuckle and bearing assembly; and
measuring said hub of said knuckle and bearing assembly to define a cutting pattern for said cutting tool.

12. The method of claim 11 wherein said cutting tool is a vertical lathe.

13. The method of claim 1, further comprising:
rotating said hub of said knuckle and bearing assembly after machining of said flange face;
measuring the lateral run-out range of said flange face; and
comparing said lateral run-out range to a predetermined lateral run-out range.

14. The method of claim 13 wherein said run-out range is measured with a Linear Variable Displacement Transducer.

15. The method of claim 13 wherein said predetermined range is from a certified knuckle and bearing assembly.

16. The method of claim 15 wherein said certified knuckle and bearing assembly has a lateral run-out value of less than 10 microns.
